(19) United States
(12) Patent Application Publication
(10) Pub. No.: US 2024/0409116 A1
(43) Pub. Date: Dec. 12, 2024

(54) VEHICLE ACTUATION CENTRIC JUDGMENT OF AUTONOMOUS DRIVING REQUESTS DERIVED FROM DIVERSE SENSOR MODALITIES

(71) Applicant: Robert Bosch GmbH, Stuttgart (DE)

(72) Inventors: Volker Niemz, Northville, MI (US); Marius Bruno Jansen, Northville, MI (US)

(21) Appl. No.: 18/332,473

(22) Filed: Jun. 9, 2023

(51) Int. Cl. B60W 60/00; B60W 10/18; B60W 10/20

(52) U.S. Cl. CPC B60W 60/001; B60W 10/18; B60W 10/20; B60W 2510/18; B60W 2510/20; B60W 2520/10; B60W 2710/18; B60W 2710/20

(57) ABSTRACT

A vehicle includes a first sensor operatively coupled to an electronic processor and a second sensor operatively coupled to the electronic processor. The electronic processor is configured to receive a first signal from the first sensor, receive a second signal from the second sensor, determine whether the first signal indicates a presence of a maneuvering condition, determine whether the second signal indicates the presence of the maneuvering condition, initiate a limited vehicle maneuver in response to determining that the first signal indicates the presence of the maneuvering condition, and initiate a full vehicle maneuver in response to determining that the first signal and the second signal indicate the presence of the maneuvering condition.

### FIELD

The present disclosure relates to vehicles and, more particularly, to judging safety of requested maneuvers of autonomous and similar vehicle control systems.

### SUMMARY

Autonomous vehicles and vehicles that are less than fully autonomous include various systems to detect their environment and maneuver in response to detected (or determined) objects and conditions (collectively, external conditions). Of course, if a vehicle incorrectly determines the existence of the external conditions, maneuvers made in response to the incorrectly determined external condition may be undesirable. To avoid shortcomings that may occur when a single type or modality of sensor is used to detect external conditions, it is often desirable to use different sensor modalities to detect external conditions. When different sensor modalities are used to determine or detect external conditions, it is possible to confirm that the external conditions exist (for example, by comparing whether the determination via two different modalities are the same) before initiating vehicle maneuvers. When such an architecture is use, an automated system (for example, an advanced driver assistance system (ADAS) or similar system) won't initiate a driving maneuver (for example, strong steering, evasive maneuver, and/or emergency braking) that could lead to a safety hazard based on a single sensor detection.

While it is generally understood that decisioning based on single sensor detections could lead to hazardous situations, it is also believed that that single sensor detection can carry important information. The inventors propose a new way of interpreting the problem that begins with an inversion of the cause-effect chain. The main problem is the unknown existence probability of a single sensor detection in the real world. That is why it is not possible to judge a single sensor detection as a true positive or a false positive without consulting a second source of information. However, a vehicle could end up in a situation in which a single sensor input is the only information the system receives (for example, rain, snow, or other environmental situations may adversely affect the operation of some sensors while not impacting others). For that reason, it is proposed to allow determinations based on single sensor detections to ensure that information about the environment from a sensor is used. However, at the end of the signal chain, when the desired vehicle maneuver is determined, a judgment about safety preference is performed. As a consequence, as long as the resulting vehicle actuator interaction (or maneuver) is small enough, the request is accepted or limited. Only if the resulting interaction could lead to a safety hazard by itself (for example, emergency braking or evasive steering) a confirmation by a second source of information is carried out before executing the maneuvering request.

According to some examples, a vehicle includes a first sensor operatively coupled to an electronic processor and a second sensor operatively coupled to the electronic processor. The electronic processor is configured to receive a first signal from the first sensor, receive a second signal from the second sensor, determine whether the first signal indicates a presence of a maneuvering condition, determine whether the second signal indicates the presence of the maneuvering condition, initiate a limited vehicle maneuver in response to determining that the first signal indicates the presence of the maneuvering condition, and initiate a full vehicle maneuver in response to determining that the first signal and the second signal indicate the presence of the maneuvering condition.

In other features, the first sensor operates according to a different sensing principle than the second sensor. In other features, the electronic processor is configured to initiate the limited vehicle maneuver by generating a steering command in response to the maneuvering condition, determining whether the steering command exceeds a limit, and setting the steering command to the limit in response to determining that the steering command exceeds the limit. In other features, the limit is a lateral deviation of the vehicle in a range of about 30 centimeters per second (cm/s) to about 60 cm/s. In other features, the limit is a lateral deviation of the vehicle of about 30 cm/s. In other features, the limit is a lateral deviation of the vehicle of about 60 cm/s.

In other features, the electronic processor is configured to initiate the limited vehicle maneuver by generating a braking command in response to the maneuvering condition, determining whether the a vehicle speed is greater than or equal to a first threshold, setting a first limit as a braking threshold in response to determining the vehicle speed is greater than or equal to the first threshold, determining whether the vehicle speed is less than a second threshold, setting a second limit as the braking threshold in response to determining the vehicle speed is less than or equal to the second threshold, determining whether the braking command exceeds the braking threshold, and setting the braking command to the braking threshold in response to determining the braking command exceeds the braking threshold.

In other features, the first threshold is about 20 meters per second (m/s), the second threshold is about 5 m/s, the first limit is a first vehicle deceleration of about −3.5 meters per second per second (m/s/s), and the second limit is a second vehicle deceleration of about −5 m/s/s. In other features, the electronic processor is configured to initiate the limited vehicle maneuver by, in response to determining that the vehicle speed is (i) not greater than or equal to the first threshold and (ii) not less than or equal to the second threshold, determining a third limit t according to t=−0.1 v+5.5, where v is the vehicle speed. In other features, the third limit is in a range of between about −3.5 m/s/s to about −5 m/s/s.

Other examples provide a method for controlling an autonomous vehicle. The method includes receiving a first signal from a vehicle sensor, receiving a second signal from the vehicle sensor, determining whether the first signal indicates a presence of a maneuvering condition, determining whether the second signal indicates the presence of the maneuvering condition, initiating a limited vehicle maneuver in response to determining that the first signal indicates the presence of the maneuvering condition, and initiating a full vehicle maneuver in response to determining that the first signal and the second signal indicate the presence of the maneuvering condition.

In other features, the vehicle sensor generates the first signal according to a different sensing principle than the second signal. In other features, initiating the limited vehicle maneuver includes generating a steering command in response to the maneuvering condition, determining whether the steering command exceeds a limit, and setting the steering command to the limit in response to determining that the steering command exceeds the limit. In other features, the limit is a lateral deviation of the vehicle in a range of about 30 centimeters per second (cm/s) to about 60 cm/s. In other features, the limit is a lateral deviation of the vehicle of about 30 cm/s. In other features, the limit is a lateral deviation of the vehicle of about 60 cm/s.

In other features, initiating the limited vehicle maneuver includes generating a braking command in response to the maneuvering condition, determining whether the a vehicle speed is greater than or equal to a first threshold, setting a first limit as a braking threshold in response to determining the vehicle speed is greater than or equal to the first threshold, determining whether the vehicle speed is less than a second threshold, setting a second limit as the braking threshold in response to determining the vehicle speed is less than or equal to the second threshold, determining whether the braking command exceeds the braking threshold, and setting the braking command to the braking threshold in response to determining the braking command exceeds the braking threshold.

In other features, the first threshold is about 20 meters per second (m/s), the second threshold is about 5 m/s, the first limit is a first vehicle deceleration of about −3.5 meters per second per second (m/s/s), and the second limit is a second vehicle deceleration of about −5 m/s/s. In other features, initiating the limited vehicle maneuver includes, in response to determining that the vehicle speed is (i) not greater than or equal to the first threshold and (ii) not less than or equal to the second threshold, determining a third limit t according to t=−0.1 v+5.5, where v is the vehicle speed. In other features, the third limit is in a range of between about −3.5 m/s/s to about −5 m/s/s.

Other examples, embodiments, features, and aspects will become apparent by consideration of the detailed description and accompanying drawings.

### BRIEF DESCRIPTION OF THE DRAWINGS

The present disclosure will become more fully understood from the detailed description and the accompanying drawings.

FIG. 1 is a block diagram of an example system for controlling a motor vehicle.

FIG. 2 is a flowchart of an example process for automatically monitoring vehicle sensors and selectively initiating vehicle maneuvers based on sensor data.

FIG. 3 is a flowchart of an example process for generating and executing a limited set of vehicle maneuvers.

FIG. 4 is a flowchart of an example process for determining whether steering commands exceed a limit.

FIG. 5 is a flowchart of an example process for determining whether braking commands exceed a limit.

In the drawings, reference numbers may be reused to identify similar and/or identical elements.

### DETAILED DESCRIPTION

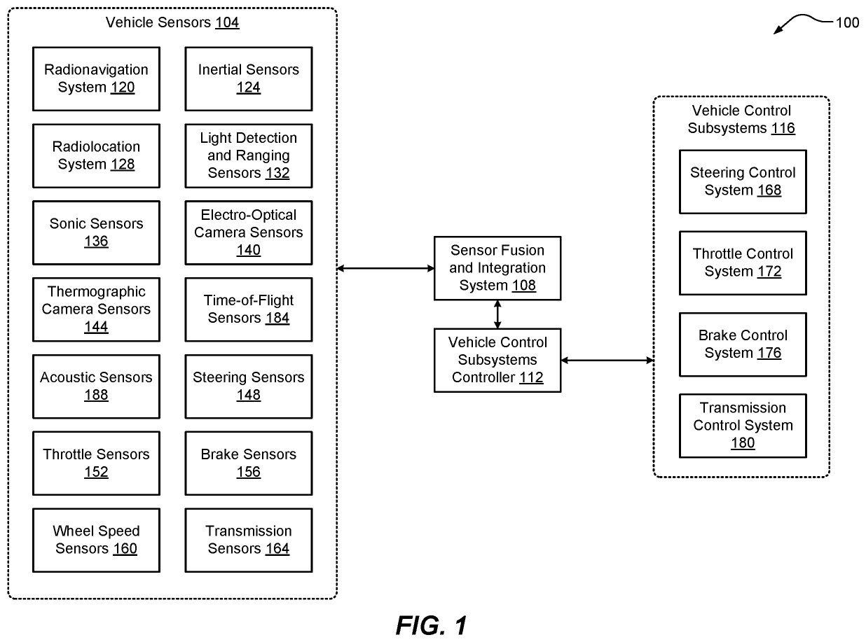

FIG. 1 is a block diagram of an example system 100 for controlling a motor vehicle. As shown in the example of FIG. 1, the system 100 may include one or more vehicle sensors 104, a sensor fusion and integration system 108, a vehicle control subsystems controller 112, and one or more vehicle control subsystems 116. In various implementations, the vehicle sensors 104, the sensor fusion and integration system 108, the vehicle control subsystems controller 112, and the vehicle control subsystems 116 may be interconnected via one or more internal communications networks, such as one or more vehicle buses. In various implementations, the components of the system 100 may be interconnected with physical transmission media, such as electrical wiring and/or optical fibers. In various implementations, the components of the system 100 may be interconnected using one or more networks types, protocols, and/or standards, such as: the Automotive Audio Bus (A²B) protocol, the Avionics Full-Duplex Switched Ethernet (ARINC 664) protocol, the Mark33 Digital Information Transfer System (ARINC 429) protocol, the Byteflight protocol, a Controller Area Network (CAN), a Domestic Digital Bus (D2B), the FlexRay protocol, the IEEE 1394 standard, an Inter Equipment Bus (IEBus), an Inter-Integrated Circuit (I²C), the ISO 9141-1/-2 standards, the SAE J1508 standard, the SAE J1587 standard, the SAE J1850 standard, the SAE J1939 standard, the ISO 11783 standard, the Keyword Protocol 2000 (KWP2000), a Local Interconnect Network (LIN), the Media Oriented Systems Transport (MOST) interface, a Multifunction Vehicle Bus, a Serial Peripheral Interface (SPI), a Vehicle Area Network (VAN), the Cyphal protocol, the Ethernet protocol, and/or the Internet protocol suite (TCP/IP).

As shown in the example of FIG. 1, the one or more vehicle sensors 104 may include a radionavigation system 120, inertial sensors 124, a radiolocation system 128, light detection and ranging sensors 132, sonic sensors 136, electro-optical camera sensors 140, thermographic camera sensors 144, time-of-flight sensors 184, acoustic sensors 188, steering sensors 148, throttle sensors 152, brake sensors 156, wheel speed sensors 160, and/or transmission sensors 164. In various implementations, the radionavigation system 120 may include a receiver for a satellite-based radionavigation system, such as a global navigation satellite system (GNSS). The receiver may receive geolocation and time information from the GNSS and calculate a two- or three-dimensional position of the receiver. In various implementations, the GNSS may be the Global Positioning System (GPS). In various implementations, the inertial sensors 124 may include a combination of accelerometers, gyroscopes, and/or magnetometers. The inertial sensors 124 may measure and report the vehicle's specific force or acceleration, angular rate, and/or orientation. In various implementations, the inertial sensors 124 may include a one-, two-, or three-axis accelerometer, a one-, two-, or three-axis gyroscope, and/or a one-, two-, or three-axis magnetometer.

The radiolocation system 128 may include transmitters and/or receivers that use radio waves to determine the distance, angle, and/or radial velocity of objects relative to the radiolocation system 128. In various implementations, the radiolocation system 128 may include a radar system, such as a frequency-modulated continuous-wave (FMCW) radar or an impulse radar. The light detection and ranging sensors 132 may include a transmitter that targets an object with a laser and measures the time it takes for the reflected laser light to return to a receiver. In various implementations, the sonic sensors 136 may include acoustic sensors that generate sound energy, transmit sound energy to a target, and measure the time interval between the emission and return of a sound pulse to determine a distance to the target. In various implementations, the sonic sensors 136 may include ultrasonic sensors. In various implementations, the ultrasonic sensors may operate in a frequency range of between about 20 kHz to about 250 KHz.

In various implementations, the electro-optical camera sensors 140 may include an electro-optical camera that includes an optical lens and a solid-state image sensor. The electro-optical camera may digitally record images from the image sensor. In various implementations, the electro-optical camera sensors 140 may capture and record still images and/or motion video based on light in the visible spectrum. In various implementations, the thermographic camera sensors 144 may include a thermographic camera that includes an optical lens and a solid-state image sensor that digitally records images from the image sensor. In various implementations, the thermographic camera sensors 144 may capture and record still images and/or motion video based on light in the infrared and/or near-infrared spectrum.

In various implementations, the time-of-flight sensors 184 may include a range imaging camera system for measuring distances between the camera system and a target. The camera system may measure distances between each point of an image taken and the camera system based on a round trip time of a light signal-such as a laser or light emitted by an LED. In various implementations, the acoustic sensors 188 may include one or more microphones and/or microphone arrays and identify a presence of acoustic signatures indicative of emergency conditions-such as acoustic signatures indicative of a presence of emergency vehicles. In various implementations, the acoustic sensors 188 may be used to estimate whether the emergency vehicles are closing with the acoustic sensors 188 or traveling away from the acoustic sensors 188 by identifying Doppler shifts in the acoustic signatures.

The steering sensors 148 may include steering angle sensors that sense a steering wheel's rate of turn and/or an angle of the steering wheel. In various implementations, the steering sensors 148 may include a torque sensor that measures an amount of force being applied by a driver to the steering wheel. The throttle sensors 152 may include a sensor used to monitor the air intake of the vehicle's engine. The throttle sensors 152 may also include a sensor used to monitor the position of the accelerator pedal, such as an accelerator pedal sensor. In various implementations, the brake sensors 156 include sensors that measure the position of brake actuators of the brake calipers. In various implementations, the brake sensors 156 include sensors that measure the clamp force of the brake calipers against the brake rotor. In various implementations, the wheel speed sensors 160 may include a sensor used for reading the speed of vehicle wheel rotation. In other examples, instead of using or in combination with wheel speed sensors a tachometer (e.g., engine speed) may be used. The transmission sensors 164 may include a sensor for detecting gear selection and transmission speed.

In various implementations, the sensor fusion and integration system 108 may receive sensor data from disparate sources-such as any combination of vehicle sensors 104—and process and/or combine the sensor data to form a more complete sensor picture for the vehicle. In some examples, the sensor fusion and integration system 108 may include one or more processors and/or graphics processing units. In some embodiments, the sensor fusion and integration system 108 may combine disparate sensor data from the vehicle sensors 104 and provide combined sensor data to the vehicle control subsystems controller 112. In various implementations, the vehicle control subsystems controller 112 may process the combined sensor data, generate vehicle commands based on the combined sensor data, and send the vehicle commands to the vehicle control subsystems 116.

The vehicle control subsystems 116 may include a steering control system 168, a throttle control system 172, a brake control system 176, and/or a transmission control system 180. In various implementations, the steering control system 168 may generate and send commands to the motor of an electric power steering system to control steering inputs of the vehicle. In some instances, the steering control system 168 may generate and send commands to electric motors of a steer-by-wire system to control steering inputs of the vehicle. The throttle control system 172 may generate and send commands to an electronic throttle control unit of the vehicle for opening and/or closing a throttle of a vehicle or, more generally, controlling acceleration of a vehicle. In a hybrid or electric vehicle, the throttle control system 172 may generate and send commands to power inverter modules of electric drive motors of the vehicle.

The brake control system 176 may generate and send commands to control the pumps, vacuum servos, and/or master cylinders of the vehicle brake system. In various implementations, the brake control system 176 may generate and send commands to control actuators of electro-mechanical calipers. In various implementations, the brake control system 176 may generate and send commands to the control system of the electric drive motors of the vehicle to reconfigure the motors to function as generators. The transmission control system 180 may control how and when the vehicle transmission shifts gears. In various implementations, the transmission control system 180 generates and sends commands to the vehicle transmission to perform gear changes.

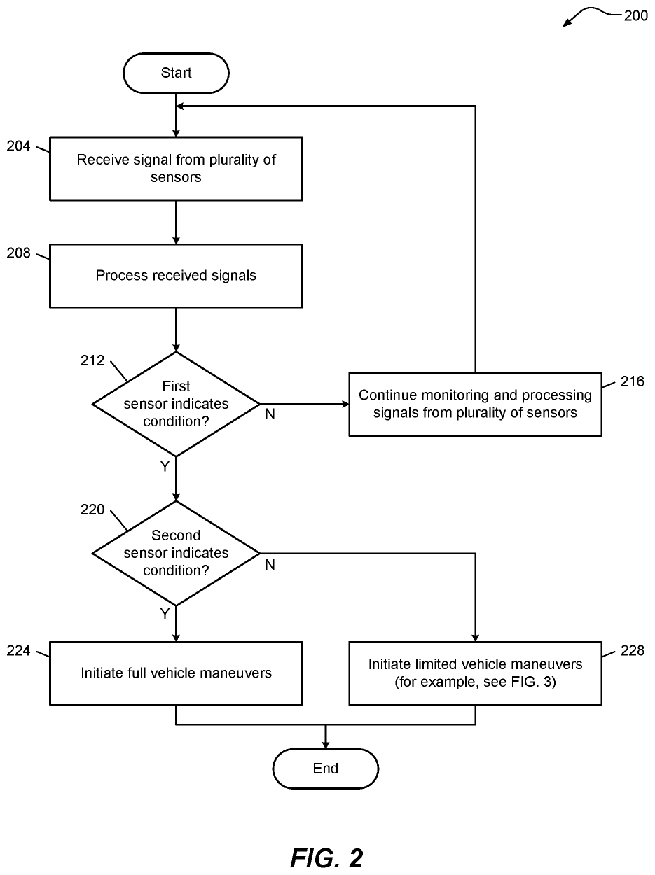

FIG. 2 is a flowchart of an example process 200 for automatically monitoring vehicle sensors and selectively initiating vehicle maneuvers based on sensor data. As shown in FIG. 2, the example process 200 begins after the sensor fusion and integration system 108 and/or the vehicle control subsystems controller 112 receives one or more signals from a plurality of sensors (at start block 204). In various implementations, the sensors may be a combination of the vehicle sensors 104 previously described with reference to FIG. 1. The example process 200 includes the sensor fusion and integration system 108 and/or the vehicle control subsystems controller 112 processing the received signals (at block 208). In various implementations, the sensor fusion and integration system 108 and/or the vehicle control subsystems controller 112 may process one or more received signals from one or more sensors of the vehicle sensors 104 to determine a presence of conditions that require vehicle maneuvering (or maneuvering conditions). For example, maneuvering conditions may include a presence of an object or obstacle in the vehicle's predicted path of travel.

The example process 200 includes the sensor fusion and integration system 108 and/or the vehicle control subsystems controller 112 determining whether data from a first sensor—such as any one of the vehicle sensors 104—indicates that a maneuvering condition is present (at decision block 212). In response to the sensor fusion and integration system 108 and/or the vehicle control subsystems controller 112 determining—based on data from the first sensor—that the maneuvering condition is not present (“NO” at decision block 212), the sensor fusion and integration system 108 and/or the vehicle control subsystems controller 112 continues monitoring and processing signals from the plurality of sensors (at block 216) and again receives signals from the plurality of sensors (at block 204). In response to the sensor fusion and integration system 108 and/or the vehicle control subsystems controller 112 determining data from the first sensor indicates that the maneuvering condition is present (“YES” at decision block 212), the sensor fusion and integration system 108 and/or the vehicle control subsystems controller 112 determines whether data from a second sensor—such as any other one of the vehicle sensors 104—indicates that the maneuvering condition is present (at decision block 220). In some embodiments, the second type of sensor is a different type of sensor from the first sensor. For example, the second type of sensor may operate according to a different sensing principle than the first sensor. In other implementations, the first sensor and the second sensor may operate according to the same sensing principle.

In response to the sensor fusion and integration system 108 and/or the vehicle control subsystems controller 112 determining—based on data from the second sensor—that the maneuvering condition is present (“YES” at decision block 220), the vehicle control subsystems controller 112 may initiate full vehicle maneuvers (at block 224). In some examples, the full vehicle maneuvers include the vehicle control subsystems controller 112 generating and sending commands to the steering control system 168 to steer the vehicle in an effort to avoid the maneuvering condition. In various implementations, the full vehicle maneuvers include the vehicle control subsystems controller 112 generating and sending commands to the throttle control system 172 to adjust throttle commands (e.g., to speed the vehicle up or slow the vehicle down) in an effort to avoid the maneuvering condition. In some instances, the full vehicle maneuvers include the vehicle control subsystems controller 112 generating and sending commands to the brake control system 176 to apply a braking force to decelerate (or slow) the vehicle in an effort to avoid the maneuvering condition.

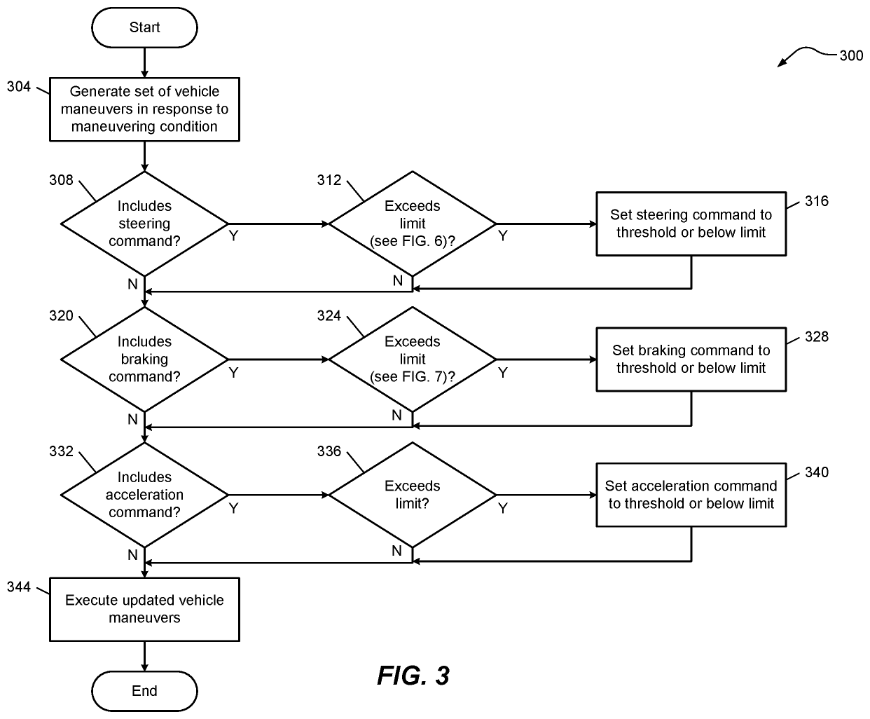

In response to the sensor fusion and integration system 108 and/or the vehicle control subsystems controller 112 being unable to determine—based on data from the second sensor—that the maneuvering condition is not present (“NO” at decision block 220), the vehicle control subsystems controller 112 may initiate limited vehicle maneuvers (at block 228). As their name implies, the limited vehicle maneuvers are different (for example, in magnitude) from the full vehicle maneuvers. In some instances, the vehicle control subsystems controller 112 initiates limited vehicle maneuvers if data from only a single sensor indicates a presence of the maneuvering condition. The limited vehicle maneuvers may include the vehicle control subsystems controller 112 generating and sending commands to the steering control system 168 to adjust the steering angle to avoid the maneuvering condition. The limited vehicle maneuvers may also include the vehicle control subsystems controller 112 generating and sending commands to the throttle control system 172 to adjust throttle commands (e.g., to speed the vehicle up or slow the vehicle down) to avoid the maneuvering condition. The limited vehicle maneuvers may also include the vehicle control subsystems controller 112 generating and sending commands to the brake control system 176 to apply a braking force to avoid the maneuvering condition. However, the magnitudes of vehicle commands of the limited vehicle maneuvers (at block 228) are less than magnitudes of vehicle commands of the full vehicle maneuvers (at block 224). Additional details of generating and initiating limited vehicle maneuvers are provided in connection with discussion of FIG. 3.

The example process 200 provides technical benefits over solutions that rely on confirmations through a second sensor. As previously discussed, single sensor—or single sensor type—detections may still provide important information. In certain situations, information may only be available to a single sensor or a single sensor type. For example, in harsh operating conditions, individual sensors or types of sensors may be unavailable or provide unreliable data. In low-light (e.g., nighttime) and/or low-visibility conditions (e.g., during fog), electro-optical camera systems may have reduced performance. Similarly, radar and lidar sensor signals may be scattered during heavy precipitation and offer diminished performance. Additionally, radar and lidar sensors are prone to occlusion through snow and/or ice buildup. Thus, in harsh operating conditions—or in the event of sensor failure—only a single sensor or a single type of sensor may be available and/or provide reliable data. The technical solutions described with reference to process 200 allow autonomous and less-than-fully-autonomous vehicles to safely perform maneuvers based on sensor information when only a single sensor or sensor type is available.

FIG. 3 is a flowchart of an example process 300 for generating and executing a limited set of vehicle maneuvers. For example, the process 300 may generate and execute the limited set of vehicle maneuvers may if data from only a single sensor of a plurality of vehicle sensors indicates a presence of a maneuvering condition. In some examples, the process 300 may generate and execute the limited set of vehicle maneuvers if data from only a single type of sensor—such as sensors that operate according to the same sensing principle—indicate the presence of the maneuvering condition. In some embodiments, the example process 300 may generate and execute the limited set of vehicle maneuvers if data from a percentage of total vehicle sensors below a threshold percentage indicates the presence of the maneuvering condition. In various implementations, the threshold percentage may be about 10%, 20%, 25%, 33%, 50%, 67%, or 75%.

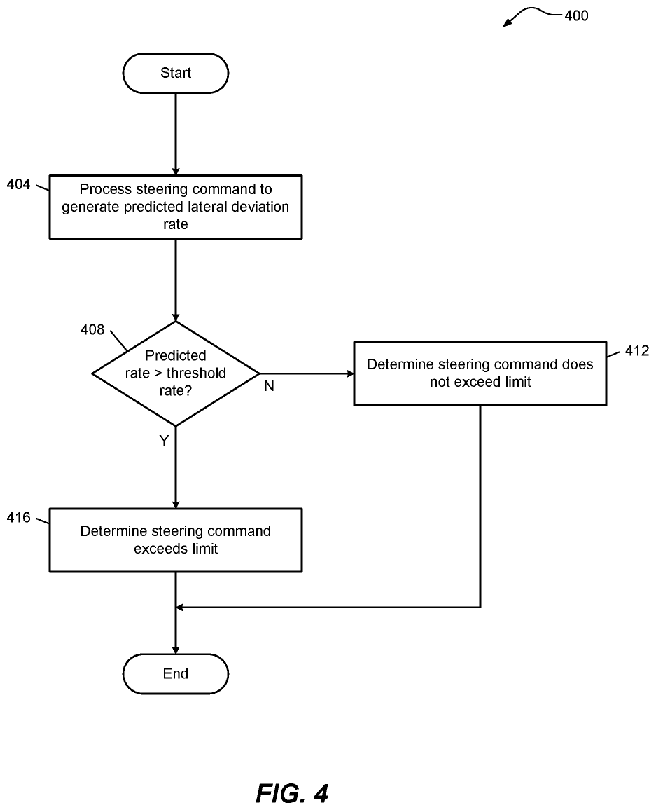

As shown in FIG. 3, the example process 300 generates a set of vehicle maneuvers in response to a detected maneuvering condition (at start block 304). For example, the vehicle control subsystems controller 112 may generate the set of vehicle maneuvers. In various implementations, the vehicle maneuvers may be any of the vehicle maneuvers previously described with reference to FIG. 2 and process 200. The example process 300 includes the sensor fusion and integration system 108 and/or the vehicle control subsystems controller 112 determining whether the set of vehicle maneuvers includes a steering command—such as a command for the steering control system 168 to adjust the steering of the vehicle (at decision block 308). In response to determining that the set of vehicle maneuvers includes a steering command (“YES” at decision block 308), the sensor fusion and integration system 108 and/or the vehicle control subsystems controller 112 determines whether the steering command will cause the vehicle to exceed a first limit (at decision block 312). In various implementations, the first limit may be a lateral deviation—for example, a deviation in a direction substantially orthogonal to the vehicle's direction of travel. The first limit may be a lateral deviation in a range of about 30 centimeters per second (cm/s) to about 60 cm/s. For example, the first limit may be a lateral deviation of about 30 cm/s. In some embodiments, the first limit may be a lateral deviation of about 60 cm/s. Additional details associated with determining whether the steering command will cause the vehicle to exceed the first limit will be described further on in this specification with reference to FIG. 4.

In response to the sensor fusion and integration system 108 and/or the vehicle control subsystems controller 112 determining that the steering command will cause the vehicle to exceed the first limit (“YES” at decision block 312), the sensor fusion and integration system 108 and/or the vehicle control subsystems controller 112 may adjust the steering command so that the vehicle does not exceed the first limit (at block 316). For example, the sensor fusion and integration system 108 and/or the vehicle control subsystems controller 112 may adjust the steering command so that the lateral deviation of the vehicle will be at the first limit. In various implementations, the sensor fusion and integration system 108 and/or the vehicle control subsystems controller 112 may adjust the steering command so that the lateral deviation of the vehicle will be below the first limit. After the steering command is set to the limit or below the first limit at block 316, the process 300 includes determining whether the set of vehicle maneuvers includes a braking command (at decision block 320).

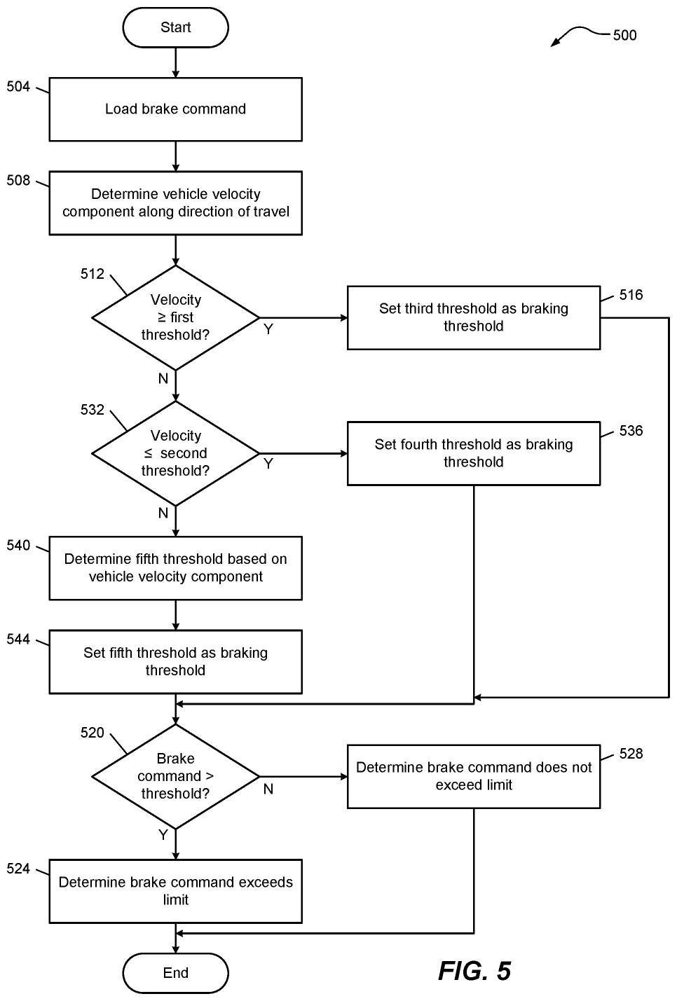

In response to the sensor fusion and integration system 108 and/or the vehicle control subsystems controller 112 determining that the steering command will not cause the vehicle to exceed the first limit (“NO” at decision block 312), the process 300 also includes determining whether the set of correction actions includes a braking command (at decision block 320). In response to the sensor fusion and integration system 108 and/or the vehicle control subsystems controller 112 determining that the set of vehicle maneuvers does not include a steering command (“NO” at decision block 308), the process 300 also includes determining whether the set of corrective actions includes a braking command (at decision block 320). In various implementations, the sensor fusion and integration system 108 and/or the vehicle control subsystems controller 112 may determine whether the set of vehicle maneuvers includes a braking command (at decision block 320). In response to the sensor fusion and integration system 108 and/or the vehicle control subsystems controller 112 determining that the set of vehicle maneuvers includes a braking command (“YES” at decision block 320), the sensor fusion and integration system 108 and/or the vehicle control subsystems controller 112 determines whether the braking commands will cause the vehicle to exceed a second limit (at decision block 324). In some examples, the second limit includes a deceleration of the vehicle along the direction of travel. The second limit may be a deceleration in a range of between about −3.5 meters per second per second (m/s/s) and about −5 m/s/s. For example, the second limit may be about −3.5 m/s/s. In other examples, the second limit may be about −5 m/s/s. Additional details associated with determining whether the braking commands will cause the vehicle to exceed the second limit will be described further on in this specification with reference to FIG. 5.

In response to the sensor fusion and integration system 108 and/or the vehicle control subsystems controller 112 determining that the braking command will cause the vehicle to exceed the second limit (“YES” at decision block 324), the sensor fusion and integration system 108 and/or the vehicle control subsystems controller 112 may adjust the braking command so that the vehicle will not exceed the second limit (at block 328). For example, the sensor fusion and integration system 108 and/or the vehicle control subsystems controller 112 may adjust the braking command so that the vehicle decelerates at the second limit. In various implementations, the sensor fusion integration system 108 and/or the vehicle control subsystems controller 112 may adjust the braking command so that the vehicle's deceleration is less than the second limit. After adjusting the braking command at block 328, the process 300 includes determining whether the set of vehicle maneuvers includes an acceleration command (at decision block 332). In response to determining that the braking command will not cause the vehicle to exceed the second limit (“NO” at decision block 324), the process 300 also includes determining whether the set of vehicle maneuvers includes an acceleration command (at decision block 332). In response to determining that the set of vehicle commands does not include a braking command (“NO” at decision block 320), the process 300 includes determining whether the set of vehicle maneuvers includes an acceleration command (at decision block 332).

In various implementations, the process 300 includes the sensor fusion and integration system 108 and/or the vehicle control subsystems controller 112 determining whether the set of vehicle maneuvers includes an acceleration command (at decision block 332). In response to determining that the set of vehicle maneuvers includes an acceleration command (“YES” at decision block 332), the process 300 includes the sensor fusion and integration system 108 and/or the vehicle control subsystems controller 112 determining whether the acceleration command exceeds a third limit (at decision block 336). The third limit may include a limit on an acceleration of the vehicle in the direction of travel. In some embodiments, the third limit may be a speed limit on the road the vehicle is traveling on. In response to determining that the acceleration command will cause the vehicle to exceed the third limit (“YES” at decision block 336), the process 300 includes the sensor fusion and integration system 108 and/or the vehicle control subsystems controller 112 adjusting the acceleration command so that it is at or below the third limit (at block 340).

After the integration system 108 and/or the vehicle control subsystems controller 112 adjusts the acceleration command so that it is at or below the third limit (at block 340), the process 300 includes executing the updated vehicle maneuvers (at block 344). In response to determining that the acceleration command will not cause the vehicle to exceed the third limit (“NO” at decision block 336), the process 300 includes executing the updated vehicle maneuvers (at block 344). In response to determining that the set of vehicle maneuvers does not include an acceleration command (“NO” at decision block 332), the process 300 includes executing the updated vehicle maneuvers (at block 344). In various implementations, executing the updated vehicle maneuvers (at block 344) may include the vehicle control subsystems controller 112 sending the updated vehicle maneuvers to the respective control system(s) of the vehicle control subsystems 116—such as previously described with reference to block 228 of process 200.

FIG. 4 is a flowchart of an example process 400 for determining whether steering commands exceed a limit. As shown in FIG. 4, the example process 400 begins when the sensor fusion and integration system 108 and/or the vehicle control subsystems controller 112 processes the steering command to generate a predicated lateral deviation rate (at block 404). In various implementations, the sensor fusion and integration system 108 and/or the vehicle control subsystems controller 112 may determine the vehicle's velocity component along its direction of travel using data from the radionavigation system 120, inertial sensors 124, wheel speed sensors 160, and/or transmission sensors 164. In some embodiments, the sensor fusion and integration system 108 and/or the vehicle control subsystems controller 112 may parse: (i) the vehicle's velocity component along its direction of travel and (ii) the steering command to determine the predicted lateral deviation rate that the steering command will cause for the vehicle. The predicted lateral deviation rate may be a predicted velocity component of the vehicle in a direction substantially orthogonal to the direction of travel of the vehicle prior to executing the steering command.

The example process 400 includes the sensor fusion and integration system 108 and/or the vehicle control subsystems controller 112 determining whether the predicted lateral deviation rate exceeds a threshold rate (at decision block 408). The threshold rate may be in a range of between about 30 cm/s to about 60 cm/s. For example, the threshold rate may be about 30 cm/s. In some embodiments, the threshold rate may be about 60 cm/s. In response to the sensor fusion and integration system 108 and/or the vehicle control subsystems controller 112 determining that the predicted lateral deviation does not exceed the threshold rate (“NO” at decision block 408), the sensor fusion and integration system 108 and/or the vehicle control subsystems controller 112 determines that the steering command does not exceed the limit (at block 412). In response to the sensor fusion and integration system 108 and/or the vehicle control subsystems controller 112 determining that the predicted lateral deviation exceeds the threshold rate (“YES” at decision block 408), the sensor fusion and integration system 108 and/or the vehicle control subsystems controller 112 determines that the steering command exceeds the limit (at block 416).

FIG. 5 is a flowchart of an example process 500 for determining whether braking commands exceed a limit. As shown in FIG. 5, the example process 500 begins when the sensor fusion and integration system 108 and/or the vehicle control subsystems controller 112 loads a brake command (at block 504). The example process 500 includes the sensor fusion and integration system 108 and/or the vehicle control subsystems controller 112 determining the vehicle's velocity component along its direction of travel (at block 508). In various implementations, the sensor fusion and integration system 108 and/or the vehicle control subsystems controller 112 may determine the vehicle's velocity component based on data from the radionavigation system 120, the inertial sensors 124, the wheel speed sensors 160, and/or the transmission sensors 164. The example process 500 includes the sensor fusion and integration system 108 and/or the vehicle control subsystems controller 112 determining whether the vehicle's velocity component is greater than or equal to a first threshold (at decision block 512). In some examples, the first threshold may be about 20 meters per second (m/s).

In response to the sensor fusion and integration system 108 and/or the vehicle control subsystems controller 112 determining that the vehicle's velocity component is greater than or equal to the first threshold (“YES” at decision block 512), the sensor fusion and integration system 108 and/or the vehicle control subsystems controller 112 sets a third threshold as the braking threshold (at block 516). In various implementations, the third threshold may be a deceleration of about −3.5 m/s/s. After the sensor fusion and integration system 108 and/or the vehicle control subsystems controller 112 sets the third threshold as the braking threshold (at block 516), the example process 500 includes determining whether the brake command exceeds the braking threshold (at decision block 520). In response to the sensor fusion and integration system 108 and/or the vehicle control subsystems controller 112 determining that the vehicle's velocity component is not greater than or equal to the first threshold (“NO” at decision block 512), the sensor fusion and integration system 108 and/or the vehicle control subsystems controller 112 determines whether the vehicle's velocity component is less than or equal to a second threshold (at decision block 532). In some embodiments, the second threshold may be about 5 m/s.

In response to the sensor fusion and integration system 108 and/or the vehicle control subsystems controller 112 determining that the vehicle's velocity component is less than or equal to the second threshold (“YES” at decision block 532), the sensor fusion and integration system 108 and/or the vehicle control subsystems controller 112 sets a fourth threshold as the braking threshold (at block 536). In various implementations, the fourth threshold may be a deceleration of about −5 m/s/s. After the sensor fusion and integration system 108 and/or the vehicle control subsystems controller 112 sets the fourth threshold as the braking threshold (at block 536), the example process 500 includes determining whether the brake command exceeds the braking threshold (at decision block 520). In response to the sensor fusion and integration system 108 and/or the vehicle control subsystems controller 112 determining that the vehicle's velocity component is not less than or equal to the second threshold (“NO” at decision block 532), the sensor fusion and integration system 108 and/or the vehicle control subsystems controller 112 determines a fifth threshold based on the vehicle's velocity component (at block 540). For example, the fifth threshold may be calculated according to equation (1) below:

$$t = - 0.1 v + 5.5 \qquad ( 1 )$$

In equation (1) above, t represents the fifth threshold, while v represents the vehicle's velocity component in meters per second (m/s). After the sensor fusion and integration system 108 and/or the vehicle control subsystems controller 112 determines the fifth threshold (at block 540), the sensor fusion and integration system 108 and/or the vehicle control subsystems controller 112 sets the fifth threshold as the braking threshold (at block 544). The example process 500 includes the sensor fusion and integration system 108 and/or the vehicle control subsystems controller 112 determining whether the brake command exceeds the braking threshold (at decision block 520). In some embodiments, the sensor fusion and integration system 108 and/or the vehicle control subsystems controller 112 may determine a predicted deceleration of the vehicle based on the brake command and/or data from the vehicle sensors 104. The sensor fusion and integration system 108 and/or the vehicle control subsystems controller 112 then determines whether the predicted deceleration of the vehicle exceeds the braking threshold. In response to determining that the predicted deceleration of the vehicle exceeds the braking threshold (“YES” at decision block 520), the sensor fusion and integration system 108 and/or the vehicle control subsystems controller 112 determines that the brake command exceeds the limit (at block 524). In response to determining that the predicted deceleration of the vehicle does not exceed the braking threshold (“NO” at decision block 520), the sensor fusion and integration system 108 and/or the vehicle control subsystems controller 112 determines that the brake command does not exceed the limit (at block 528).

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more steps within any given method may be executed in a different order—or steps may be executed concurrently—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrates the flow of information—such as data or instructions. However, the direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element.

Throughout this application, the term “module” or the term “controller” may be replaced with the term “circuit.” A “module” may refer to, be part of, or include processor hardware that executes code and memory hardware that stores code executed by the processor hardware. The term “module” may include one or more interference circuits. In various implementations, the interference circuits may implement wired or wireless interfaces that connect to or are part of communications systems. Modules may communicate with other modules using the interference circuits. In various implementations, the functionality of modules may be distributed among multiple modules that are connected via communications systems. For example, functionality may be distributed across multiple modules by a load balancing system. In various implementations, the functionality of modules may be split between multiple computing platforms connected by communications systems.

The term “code” may include software, firmware, and/or microcode, and may refer to programs, routines, functions, classes, data structures, and/or data objects. The term “memory hardware” may be a subset of the term “computer-readable medium.” The term computer-readable medium does not encompass transitory electrical or electromagnetic signals or electromagnetic signals propagating through a medium—such as on an electromagnetic carrier wave. The term “computer-readable medium” is considered tangible and non-transitory. Modules, methods, and apparatuses described in this application may be partially or fully implemented by a special-purpose computer that is created by configuring a general-purpose computer to execute one or more particular functions described in computer programs. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or they may be distributed among different computing devices—such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. A vehicle comprising:
a first sensor operatively coupled to an electronic processor; and
a second sensor operatively coupled to the electronic processor;
wherein the electronic processor is configured to:
receive a first signal from the first sensor,
receive a second signal from the second sensor,
determine whether the first signal indicates a presence of a maneuvering condition,
determine whether the second signal indicates the presence of the maneuvering condition,
in response to determining that the first signal indicates the presence of the maneuvering condition, initiate a limited vehicle maneuver, and
in response to determining that the first signal and the second signal indicate the presence of the maneuvering condition, initiate a full vehicle maneuver.

2. The vehicle of claim 1 wherein the first sensor operates according to a different sensing principle than the second sensor.

3. The vehicle of claim 1 wherein the electronic processor is configured to initiate the limited vehicle maneuver by:
generating a steering command in response to the maneuvering condition;
determining whether the steering command exceeds a limit; and
in response to determining that the steering command exceeds the limit, setting the steering command to the limit.

4. The vehicle of claim 3 wherein the limit is a lateral deviation of the vehicle in a range of about 30 centimeters per second (cm/s) to about 60 cm/s.

5. The vehicle of claim 3 wherein the limit is a lateral deviation of the vehicle of about 30 cm/s.

6. The vehicle of claim 3 wherein the limit is a lateral deviation of the vehicle of about 60 cm/s.

7. The vehicle of claim 1 wherein the electronic processor is configured to initiate the limited vehicle maneuver by:
generating a braking command in response to the maneuvering condition;
determining whether the a vehicle speed is greater than or equal to a first threshold;
in response to determining the vehicle speed is greater than or equal to the first threshold, setting a first limit as a braking threshold;
determining whether the vehicle speed is less than a second threshold;
in response to determining the vehicle speed is less than or equal to the second threshold, setting a second limit as the braking threshold;
determining whether the braking command exceeds the braking threshold; and
in response to determining the braking command exceeds the braking threshold, setting the braking command to the braking threshold.

8. The vehicle of claim 7 wherein:
the first threshold is about 20 meters per second (m/s);
the second threshold is about 5 m/s;
the first limit is a first vehicle deceleration of about −3.5 meters per second per second (m/s/s); and
the second limit is a second vehicle deceleration of about −5 m/s/s.

9. The vehicle of claim 7 wherein the electronic processor is configured to initiate the limited vehicle maneuver by:
in response to determining that the vehicle speed is (i) not greater than or equal to the first threshold and (ii) not less than or equal to the second threshold, determining a third limit t according to:
$$t = - 0.1 v + 5.5$$
wherein v is the vehicle speed.

10. The vehicle of claim 9 wherein the third limit is in a range of between about −3.5 m/s/s to about −5 m/s/s.

11. A method for controlling an autonomous vehicle comprising:
receiving a first signal from a vehicle sensor,
receiving a second signal from the vehicle sensor,
determining whether the first signal indicates a presence of a maneuvering condition,
determining whether the second signal indicates the presence of the maneuvering condition,
in response to determining that the first signal indicates the presence of the maneuvering condition, initiating a limited vehicle maneuver, and
in response to determining that the first signal and the second signal indicate the presence of the maneuvering condition, initiating a full vehicle maneuver.

12. The method of claim 11 wherein the vehicle sensor generates the first signal according to a different sensing principle than the second signal.

13. The method of claim 11 wherein initiating the limited vehicle maneuver includes:
generating a steering command in response to the maneuvering condition;
determining whether the steering command exceeds a limit; and
in response to determining that the steering command exceeds the limit, setting the steering command to the limit.

14. The method of claim 13 wherein the limit is a lateral deviation of the vehicle in a range of about 30 centimeters per second (cm/s) to about 60 cm/s.

15. The method of claim 13 wherein the limit is a lateral deviation of the vehicle of about 30 cm/s.

16. The method of claim 13 wherein the limit is a lateral deviation of the vehicle of about 60 cm/s.

17. The method of claim 11 wherein initiating the limited vehicle maneuver includes:
generating a braking command in response to the maneuvering condition;
determining whether the a vehicle speed is greater than or equal to a first threshold;
in response to determining the vehicle speed is greater than or equal to the first threshold, setting a first limit as a braking threshold;
determining whether the vehicle speed is less than a second threshold;
in response to determining the vehicle speed is less than or equal to the second threshold, setting a second limit as the braking threshold;
determining whether the braking command exceeds the braking threshold; and
in response to determining the braking command exceeds the braking threshold, setting the braking command to the braking threshold.

18. The method of claim 17 wherein:
the first threshold is about 20 meters per second (m/s);
the second threshold is about 5 m/s;
the first limit is a first vehicle deceleration of about −3.5 meters per second per second (m/s/s); and
the second limit is a second vehicle deceleration of about −5 m/s/s.

19. The method of claim 17 wherein initiating the limited vehicle maneuver includes:
in response to determining that the vehicle speed is (i) not greater than or equal to the first threshold and (ii) not less than or equal to the second threshold, determining a third limit t according to:
$$t = - 0.1 v + 5.5$$
wherein v is the vehicle speed.

20. The method of claim 19 wherein the third limit is in a range of between about −3.5 m/s/s to about −5 m/s/s.
